(19) United States
(12) Patent Application Publication
(10) Pub. No.: US 2004/0028319 A1
(43) Pub. Date: Feb. 12, 2004

(54) Optical communication system and method

(76) Inventors: Mahesh Ajgaonkar, New Brunswick, NJ (US); Andrey Kobyakov, North Brunswick, NJ (US); June-Koo Rhee, Morganville, NJ (US); Manish Sharma, Princeton, NJ (US); Ioannis Tomkos, Somerset, NJ (US); Michael Vasilyev, Belle Mead, NJ (US); James M. Grochocinski, Corning, NY (US); Shiva Kumar, Painted Post, NY (US); Gregory G. Luther, Hartford, CT (US)

Correspondence Address: CORNING INCORPORATED, SP-TI-3-1, CORNING, NY, 14831

(21) Appl. No.: 10/613,966

(22) Filed: Jul. 3, 2003

Related U.S. Application Data
(60) Provisional application No. 60/393,667, filed on Jul. 3, 2002.

(51) Int. Cl. G02B 6/26; G02B 6/42

(52) U.S. Cl. 385/16

(57) ABSTRACT

An optical communication system that includes an optical network is disclosed having a plurality of nodes and a plurality of optical fiber links which includes optical fiber links that interconnect the nodes. Signals passing through the network are similarly pre-compensated and/or similarly post-compensated. The network preferably includes dispersion-managed optical fiber spans, and preferably further includes distributed amplification, preferably erbium amplifiers and/or Raman amplifiers. Preferably, the network is transparent.

### BACKGROUND OF THE INVENTION

1. Field of the Invention

The present invention relates to optical communication systems and methods of communicating over optical fiber networks.

2. Technical Background

Rapidly growing IP traffic, including data and Internet traffic, along with the requirement for networking high-capacity traffic-pipes originating from various locales, have resulted in a growing interest in long-haul and ultra-long-haul (ULH) networks, and in particular for terrestrial networks. For example, Internet traffic tends to travel much longer distances than conventional voice circuits and therefore require longer connection distances, i.e. longer connection circuits.

For point-to-point transmission systems a dispersion map can be implemented to enable optimum performance at the maximum reach distance by minimizing the effects of fiber non-linearities. However, acceptable performance at maximum reach does not necessarily result in acceptable performance at shorter distances. Therefore, dispersion management requirements in optical networks are quite different than in point-to-point systems since WDM channels arriving at the same node may have originated from different locations or points and therefore may have different amounts of accumulated dispersion, thereby possibly impacting the capability for traffic add/drop at any point across the network. Thus, different optical channels or wavelengths traveling on the same optical fiber may have significantly different histories, as the signals may have, for example, originated from different locations in the network, and/or the signals may have traveled different distances within the network.

### SUMMARY OF THE INVENTION

In one aspect, a method of communicating over an optical network having a plurality of add/drop nodes interconnected by optical fiber is disclosed herein.

In a first preferred embodiment disclosed herein, the method comprises: producing a plurality of optical signals, including first and second optical signals; pre-compensating the dispersion of the first and second signals by a substantially similar magnitude and with the same sign; transporting the first signal to a first drop location; and transporting the second signal to a second drop location. The first and second optical signals may be produced at a common source location, or the first and second optical signals may be produced at different source locations. The method may further comprise, after carrying the first and second signals to the respective first and second drop locations, post-compensating the first and second signals by a substantially similar magnitude and with the same sign. Preferably, the first and second signals temporally overlap. Preferably, the first and second signals are pre-compensated simultaneously, even more preferably by propagating both signals through the same dispersion compensating device.

Preferably, the plurality of optical signals is produced at a plurality of source locations. In a preferred embodiment, greater than 25% of all of the optical signals produced are dispersion pre-compensated by a substantially similar magnitude and with the same sign. In another preferred embodiment, greater than 50% of all of the optical signals produced are dispersion pre-compensated by a substantially similar magnitude and with the same sign. In still another preferred embodiment, greater than 75% of all of the optical signals produced are dispersion pre-compensated by a substantially similar magnitude and with the same sign. In yet another preferred embodiment, substantially all of the optical signals produced are dispersion pre-compensated by a substantially similar magnitude and with the same sign.

Preferably, a plurality of optical signals is produced at a common source location, and preferably greater than 25%, more preferably greater than 50%, even more preferably greater than 75% of the optical signals produced at the common source location are dispersion pre-compensated by a substantially similar magnitude and with the same sign. In a preferred embodiment, all of the optical signals produced at the common source location are dispersion pre-compensated by a substantially similar magnitude and with the same sign.

In a second preferred embodiment disclosed herein, the method comprises: producing a first second optical signal at a first source location; producing a second optical signal at a second source location; carrying the first and second signals to a common drop location; and post-compensating the first and second signals by a substantially similar magnitude and with the same sign. The method may further comprise, before carrying the first and second signals to a common drop location, pre-compensating the dispersion of the first and second signals by a substantially similar magnitude and with the same sign. Preferably, the first and second signals temporally overlap. Preferably, the first and second signals are post-compensated simultaneously, even more preferably by propagating both signals through the same dispersion compensating device.

In one preferred embodiment, the first and second optical signals are produced at a common source location. In another preferred embodiment, the first and second optical signals are produced at different source locations.

Preferably, the plurality of optical signals is produced at a plurality of source locations. The plurality of optical signals may be produced at a common source location. Whether the optical signals are produced at a plurality of source locations or at a single source location, preferably, greater than 25% of all of the optical signals dropped are dispersion post-compensated by a substantially similar magnitude and with the same sign. More preferably, greater than 50%, even more preferably, greater than 75% of all of the optical signals dropped are dispersion post-compensated by a substantially similar magnitude and with the same sign. In a preferred embodiment, substantially all of the optical signals dropped are dispersion post-compensated by a substantially similar magnitude and with the same sign.

In a third preferred embodiment disclosed herein, the method comprises: producing a plurality of optical signals, including first and second optical signals; pre-compensating the dispersion of the first and second signals by a substantially similar magnitude and with the same sign; transporting the first and second signals through the optical network along respective optical paths of substantially different lengths; and dropping the first and second signals. Preferably, the first and second signals temporally overlap. Preferably, the first and second signals are pre-compensated simultaneously. In one preferred embodiment, the first and second signals are added at the same node. In another preferred embodiment, the first and second signals are dropped at the same node, and preferably post-compensated by substantially similar amounts of dispersion. Preferably, both signals are post-compensated by propagating both signals through the same dispersion compensator.

In another aspect, an optical communication system is disclosed herein, the system comprising an optical network, preferably transparent, which comprises a plurality of nodes and a plurality of optical fiber links which includes optical fiber links that interconnect the nodes, wherein signals passing through the network are similarly pre-compensated and/or similarly post-compensated. The network preferably includes dispersion-managed optical fiber spans, and preferably further comprises distributed amplification, preferably erbium amplifiers and/or Raman amplifiers.

Reference will now be made in detail to the present preferred embodiments of the invention, examples of which are illustrated in the accompanying drawings. An exemplary embodiment of a segmented core refractive index profile in accordance with the present invention is shown in each of the figures.

### BRIEF DESCRIPTION OF THE DRAWINGS

FIG. 1 schematically illustrates an optical communication system comprising an optical network as disclosed herein.

FIG. 2 schematically illustrates a preferred embodiment of a dispersion pre-compensation means as disclosed herein.

FIG. 3 schematically illustrates another preferred embodiment of a dispersion pre-compensation means as disclosed herein.

FIG. 4 schematically illustrates a preferred embodiment of a dispersion post-compensation means as disclosed herein.

FIG. 5 schematically illustrates a representative portion of an optical communication system as disclosed herein.

FIG. 6 schematically shows a resonant dispersion map as disclosed herein.

FIG. 7a schematically shows a nonresonant dispersion map as disclosed herein.

FIG. 7b schematically illustrates a portion of one preferred embodiment of an optical network as disclosed herein.

FIG. 7c schematically illustrates a dispersion map for a representative signal passing through the entire portion of the optical network of FIG. 7b.

FIG. 7d schematically illustrates a dispersion map for a representative signal passing through part of the portion of the optical network of FIG. 7b.

FIG. 8 shows the calculated OSNR values along the length of the circuit propagating through one preferred embodiment of an optical network as disclosed herein.

FIG. 9 shows the calculated Q-factor values corresponding to the OSNR values shown in FIG. 8, wherein all other sources of signal impairment have been ignored.

FIG. 10 shows the accumulated dispersion for a per-span under-compensation of 30 ps/nm and different amounts of pre-compensation, −1000 ps/nm and −2000 ps/nm, obtained from an experimental setup as disclosed herein.

FIG. 11 shows the calculated dispersion-induced eye-closure penalty evolution for the two cases represented by FIG. 10.

FIG. 12 shows Q-factor values for the two cases represented by FIG. 10.

FIG. 13 presents a comparison of the Q-factors obtained by using (1) pre-compensation only without any post-compensation, and, (2) post-compensation only without any pre-compensation, for a typical transmission system.

FIG. 14 schematically represents an experimental network setup as disclosed herein.

FIG. 15 schematically represents an optical add/drop multiplexers (OADMs) for use in a system as disclosed herein.

FIG. 16 schematically represents an optical cross-connect for use in a system as disclosed herein.

FIG. 17 graphically illustrates Q-factor performance and accumulated dispersion values obtained as disclosed herein.

FIG. 18 graphically illustrates Q-factor performance results for 10 Gb/s signals obtained for pre-compensation only (no post-compensation), optimized pre- and post-compensation for every distance, and fixed pre- and post-compensation to optimize the performance for the maximum reach, as disclosed herein.

### DETAILED DESCRIPTION OF THE PREFERRED EMBODIMENT

Additional features and advantages of the invention will be set forth in the detailed description which follows and will be apparent to those skilled in the art from the description or recognized by practicing the invention as described in the following description together with the claims and appended drawings.

“Chromatic dispersion”, herein referred to as “dispersion” unless otherwise noted, of a waveguide fiber is the sum of the material dispersion, the waveguide dispersion, and the inter-modal dispersion. In the case of single mode waveguide fibers the inter-modal dispersion is zero.

A span of optical fiber as used herein includes a length of optical fiber, or a plurality of optical fibers fused together serially, extending between optical devices, for example between two optical amplifiers, or between a multiplexing device and an optical amplifier. A span may comprise one or more sections of optical fiber as selected to achieve a desired system performance or parameter such as residual dispersion at the end of a span.

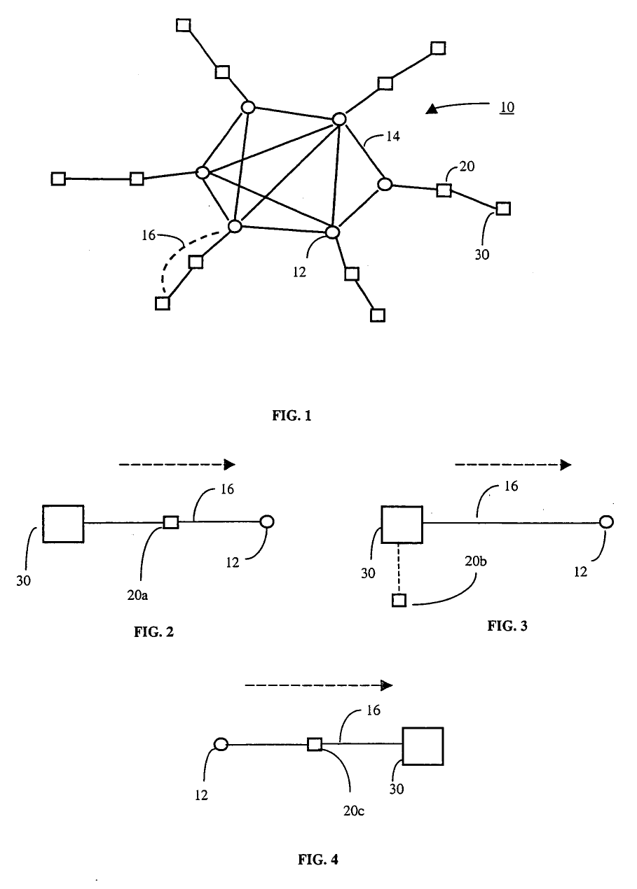

Referring to FIG. 1, an optical communication system 10 is disclosed herein which comprises an optical network, preferably transparent, which comprises a plurality of nodes 12, a plurality of optical fiber links 14, 16 connected to the nodes, and dispersion compensating means 20, wherein signals passing through the network are preferably similarly pre-compensated and/or similarly post-compensated. The optical fiber links preferably comprise one or more optical fibers. The optical fiber links preferably include interconnecting links 14 that optically interconnect the plurality of nodes 12, and external branch links 16, each optically connected to at least one of the nodes 12. The external branch links 16 are suitable for optically connecting a terminal 30 which may serve as an optical signal source or destination. The terminal 30 may include, for example, one or more transmitters and/or one or more receivers. The network preferably includes dispersion-managed optical fiber spans, and preferably further comprises distributed amplification. Preferably erbium amplifiers and/or Raman amplifiers are distributed between sections of optical fiber throughout one or more of the optical fiber links. Preferably, at least the interconnecting links comprise dispersion-managed optical fiber spans.

Preferably, a majority of the signal traffic passes transparently through the network nodes. More preferably, all of the signal traffic passes transparently through the network nodes.

FIG. 2 schematically illustrates one preferred embodiment of a dispersion compensating means which is a dispersion pre-compensation means or dispersion pre-compensator 20a optically coupled to and disposed between an optical signal source and a node. The optical signal source preferably comprises at least one transmitter. Terminal 30 preferably includes one or more transmitters. As represented by the directional arrow, at least one signal originates from the source and passes through the pre-compensator to be added at the node.

FIG. 3 schematically illustrates another preferred embodiment of a dispersion compensating means which is a dispersion pre-compensation means which includes a precompensator 20b such as a controller or modulator for inducing chirp. Terminal 30 preferably includes one or more transmitters.

FIG. 4 schematically illustrates one preferred embodiment of a dispersion compensating means which is a dispersion post-compensation means. A post-compensator 20c is optically coupled to and disposed between a node and an optical signal destination. The optical signal destination preferably comprises at least one receiver. As represented by the directional arrow, at least one signal is dropped at the node and passes through the post-compensator to be delivered to the signal destination. Terminal 30 preferably includes one or more receivers.

Preferably, the pre-compensation and/or post-compensation is scaled to support the longest possible optical path in the network, wherein the same or substantially similar amount of pre-compensation and/or post-compensation is applied for all other, i.e. shorter, paths. Pre-compensation may be of either positive or negative sign. Post-compensation may also be of either positive or negative sign. Post-compensation is applied to signals that are dropped or terminated at a node. Pre-compensation is applied to signals entering a node, i.e. to signals added at a node. Signals passing through a node, i.e. wherein the signal is neither added nor dropped, would not be imparted with pre-compensation or post-compensation.

Preferably, at least one of the optical fiber links comprises first and second amplifiers and an optical fiber span optically coupling the first and second amplifiers. Preferably, the optical fiber span comprises optical fiber sections having dispersions of alternating sign at a particular wavelength. In another implementation, the fiber span consists of a single type of fiber with constant dispersion, and a dispersion compensating device in the mid stage of the amplifier before or after the fiber span. The dispersion compensating device has similar magnitude but opposite sign of dispersion to the fiber span.

In one group of preferred embodiments, the residual dispersion per span is non-zero. In one preferred embodiment, the magnitude of the residual dispersion per span is greater than 10 ps/nm. In another preferred embodiment, the magnitude of the residual dispersion per span is greater than 20 ps/nm. In still another preferred embodiment, the magnitude of the residual dispersion per span is greater than 50 ps/nm. In yet another preferred embodiment, the magnitude of the residual dispersion per span is greater than 100 ps/nm. In another preferred embodiment, the magnitude of the residual dispersion per span is between 10 ps/nm and 120 ps/nm. In yet another preferred embodiment, the magnitude of the residual dispersion per span is between 20 ps/nm; and 100 ps/nm.

Preferably, no additional dispersion compensation is present between any two nodes above and beyond the per-span dispersion compensation between the two nodes.

In another group of preferred embodiments, the residual dispersion per span is substantially zero. In one preferred embodiment, the magnitude of the residual dispersion per span is less than 10 ps/nm. In another preferred embodiment, the magnitude of the residual dispersion per span is less than 5 ps/nm.

Preferably, the optical fiber span comprises at least one optical fiber section having a positive dispersion at a wavelength and at least one optical fiber section having a positive dispersion at the wavelength. In a preferred embodiment, the optical fiber span comprises optically coupled first, second and third optical fiber sections, the first optical fiber section having a dispersion of negative or positive sign at a wavelength, the second optical fiber section having a dispersion of opposite sign at the wavelength, and the third optical fiber section having a dispersion of like sign at the wavelength. Thus, the optical fiber span may comprise positive-negative-positive, or negative-positive-negative, sections of optical fiber. In another implementation, the fiber span consists of a single type of fiber with constant dispersion, and a dispersion compensating device in the mid stage of the amplifier before or after the fiber span. The dispersion compensating device has similar magnitude but opposite sign of dispersion to the fiber span

Preferably, at least two of the nodes are spaced apart by at least about 500 km.

Preferably, a signal carried within the system is capable of being transported along an optical path having a length of at least about 500 km, more preferably at least about 1500 km, even more preferably at least about 2500 km.

Most preferably, the signal dispersion pre-compensation means is a fixed-dispersion device. The fixed-dispersion device is preferably disposed between and optically couples an optical signal source to a node.

The signal dispersion pre-compensation means preferably comprises a small number of devices through each of which multiple signals pass. More preferably, the signal dispersion pre-compensation means consists of a single device through which both the first and second signals pass.

The signal dispersion pre-compensation means is, for example: an optical fiber, whether disposed within a module or otherwise laid out or deployed in the network; an optical grating; a controller for directly modulating the optical signal source, wherein the the controller may introduce adiabatic chirp or transient chirp to signals emanating from the optical signal source; and/or a modulator for externally modulating the optical signals. In one preferred embodiment, the signal pre-compensation means comprises a dispersion compensating module. Preferably, the signal pre-compensation means comprises a portion of optical fiber having a desired length and desired chromatic dispersion at one or more desired wavelengths.

Alternatively, the signal pre-compensation means may comprise a variable-dispersion tunable device.

The signal dispersion post-compensation means is, for example, an optical fiber, whether disposed within a module or otherwise laid out or deployed in the network, and/or optical grating. In one preferred embodiment, the signal post-compensation means comprises a dispersion compensating module. Preferably, the signal post-compensation means comprises a portion of optical fiber having a desired length and desired chromatic dispersion at one or more desired wavelengths.

Preferably, the optical signal source comprises one or more transmitters.

For systems with pre-compensation, preferably greater than 50%, more preferably greater than 80%, and most preferably all of the signals generated by the optical signal source are each pre-compensated with dispersion compensation having substantially similar magnitude and the same sign. For systems with post-compensation, preferably greater than 50%, more preferably greater than 80%, and most preferably all of the signals generated by the optical signal source are each post-compensated with dispersion compensation having substantially similar magnitude and the same sign.

In one preferred embodiment, at least one of the first and second signals is capable of being transported at a bit rate of about 10 Gb/s, more preferably at bit rates of between about 9 and about 13 Gb/s. In another preferred embodiment, at least one of the first and second signals is capable of being transported at a bit rate of about 40 Gb/s, more preferably at bit rates of between about 39 and about 44 Gb/s.

In one preferred embodiment, at least one signal is capable of being transported along an optical path having a length of at least about 1500 km and at a bit rate of between about 9 and about 13 Gb/s. In another preferred embodiment, at least one signal is capable of being transported along an optical path having a length of at least about 2500 km and at a bit rate of about 10 Gb/s.

In yet another preferred embodiment, at least one signal is capable of being transported along an optical path having a length of at least about 500 km and at a bit rate of between about 39 and about 44 Gb/s.

Preferably, the external branch links are capable of unidirectional signal propagation.

Preferably, the system has dynamic traffic add-drop capability of a large number of channels at each node, for example as provided by an optical add-drop multiplexer (OADM) or optical cross connect (OXC). High-capacity transport can be achieved by using DWDM technology and high data rate per channel. In one preferred embodiment, the optical communication system comprises an ultra-long haul network that operates at 10 Gb/s bit-rate per channel with spectral efficiency of 0.2 to 0.4.

Preferably, the dispersion map scheme implemented in the system or network enables ULH transmission with the capability of traffic add/drop at any point in the network. Components, such as dispersion managed fiber, static or dynamic dispersion compensation modules, and/or per channel or broadband dispersion compensation modules may be utilized.

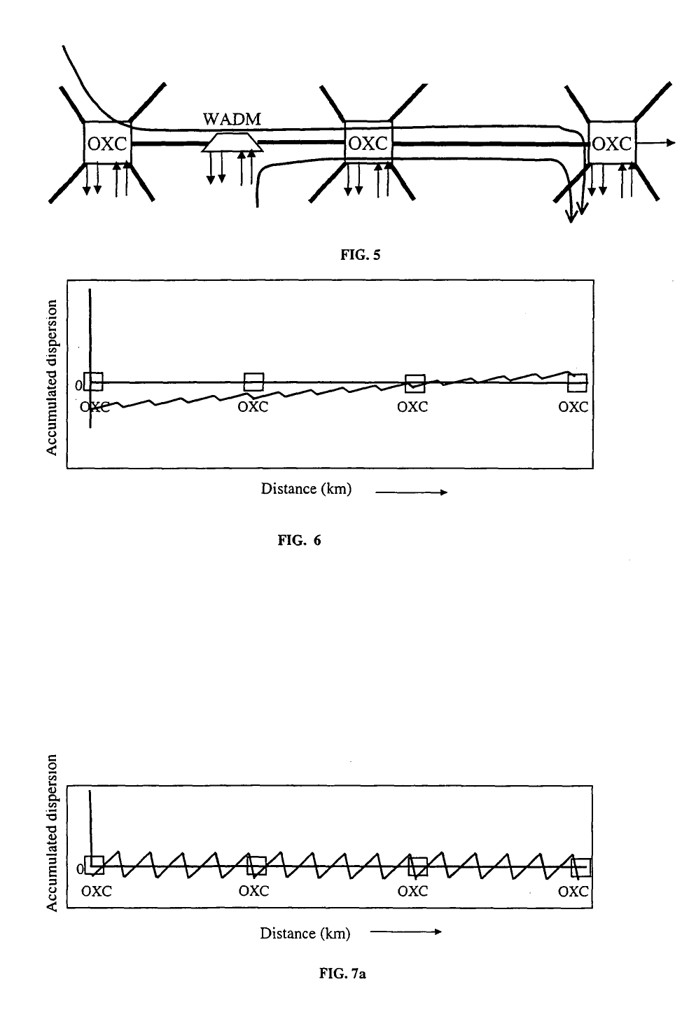

FIG. 5 schematically illustrates a representative portion of the optical communication system. Four nodes accommodate three OXC's and one WADM at respective nodes and are optically coupled by interconnecting optical fiber links. A first signal enters the first node from elsewhere in the network, passes through the second and third nodes, and is dropped by the third OXC at the fourth node. A second signal is added at the second node by the WADM, passes through the third node, and is dropped at the fourth node. The solid arrowheads in FIG. 5 indicate the capability of carrying signals in the indicated directions.

Preferably, the network comprises optical cross-connects that can switch whole channels optically without conversion to an electrical domain, and that can redirect the channels. More preferably, the network comprises fully functional reconfigurable OADMs and OXCs.

FIG. 6 schematically shows a preferred non-resonant dispersion map for 10 Gb/s operation. The resonant dispersion map is also preferred for 2.5 Gb/s operation.

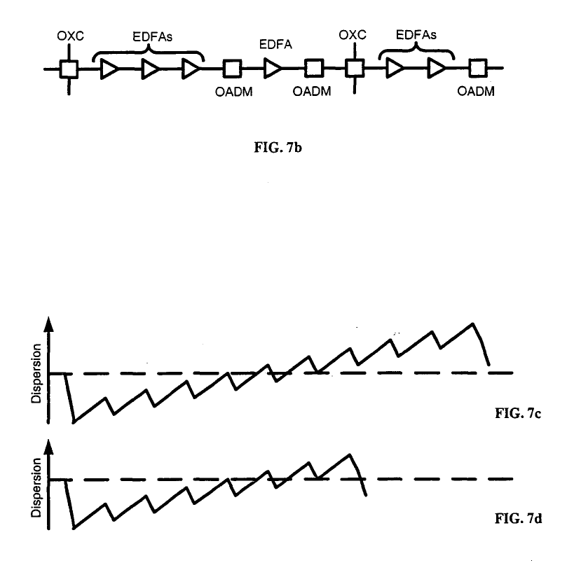

FIG. 7a schematically shows a preferred resonant dispersion map for 40 Gb/s operation. Preferably, the dispersion maps in FIGS. 6 and 7a are provided by dispersion managed fiber connecting the nodes.

FIG. 7b schematically illustrates a portion of one preferred embodiment of an optical network as disclosed herein. Two OXC's and three OADM's occupy five respective nodes. EDFA's are disposed in the interconnecting dispersion managed optical fiber links.

FIG. 7c schematically illustrates the dispersion map for a signal added at the first OXC at the far left of FIG. 7b and dropped at the second OADM at the far right of FIG. 7b. The signal is pre-compensated in the branch link (not shown) that feeds the signal into the node occupied by the first OXC, as represented by the initial drop in dispersion on the dispersion map of FIG. 7c. The signal is also post-compensated in the branch link (not shown) that carries the signal away from the node occupied by the second OADM, as represented by the final drop in dispersion on the dispersion map of FIG. 7c.

FIG. 7d schematically illustrates the dispersion map for a signal added at the first OXC at the far left of FIG. 7b and dropped at the second OXC at the right of FIG. 7b. The signal is pre-compensated in the branch link (not shown) that feeds the signal into the node occupied by the first OXC, as represented by the initial drop in dispersion on the dispersion map of FIG. 7c. The signal is also post-compensated in the branch link (not shown) that carries the signal away from the node occupied by the second OXC, as represented by the final drop in dispersion on the dispersion map of FIG. 7d. The signal in FIG. 7d travels a shorter distance than the signal in FIG. 7c.

In both FIGS. 7c and 7d, the dispersion managed fiber imparts per-span undercompensation, and no additional dispersion compensation is present between any two nodes beyond the per-span dispersion compensation between the nodes.

In one set of preferred embodiments disclosed herein, an optical communications system comprises: an optical signal source capable of generating a plurality of signals at a plurality of wavelengths, including first and second signals; a plurality of nodes including first, second and third nodes; a plurality of optical fiber links including interconnecting links that optically interconnect the plurality of nodes, and external branch links, each optically connected to at least one of the nodes, including a first external branch link that optically connects the first node to the optical signal source; and, a signal dispersion pre-compensation means optically coupled to the first external branch link. The first and second signals are pre-compensated by a substantially similar magnitude and with the same sign prior to entering the first node. The first signal is added at the first node, then transported to and dropped at the second node. The second signal is added at the first node, then transported to and dropped at the third node.

Preferably, the first and second signals are pre-compensated to within 100 ps/nm of each other, more preferably to within 50 ps/nm of each other.

In one preferred embodiment, the first and second signals are pre-compensated by a magnitude of at least 50 ps/nm. In another preferred embodiment, the first and second signals are pre-compensated by a magnitude of at least 100 ps/nm. In still another preferred embodiment, the first and second signals are pre-compensated by a magnitude of at least 500 ps/nm. In yet another preferred embodiment, the first and second signals are pre-compensated by a magnitude of at least 1000 ps/nm.

The signal dispersion pre-compensation means preferably comprises a small number of devices through each of which multiple signals pass. More preferably, the signal dispersion pre-compensation means consists of a single device through which both the first and second signals pass.

Preferably, the first and second signals temporally overlap. In one preferred embodiment, the first and second signals temporally overlap and occur in at least one common location in the network.

Preferably, the first and second signals are each pre-compensated substantially simultaneously.

In one preferred embodiment, at least one of the first and second signals is capable of being transported along an optical path having a length of at least about 1500 km and at a bit rate of between about 9 and about 13 Gb/s. In another preferred embodiment, at least one of the first and second signals is capable of being transported along an optical path having a length of at least about 2500 km and at a bit rate of about 10 Gb/s.

In yet another preferred embodiment, at least one of the first and second signals is capable of being transported along an optical path having a length of at least about 500 km and at a bit rate of between about 39 and about 44 Gb/s.

Preferably, greater than 50%, more preferably greater than 80%, and most preferably all of the signals generated by the optical signal source are each pre-compensated with dispersion compensation having substantially similar magnitude and the same sign prior to entry into the first node.

The system preferably further comprises a second external branch link optically coupled to the second node. At least one receiver is preferably optically coupled to the second node by the second external branch link. The system preferably further comprises a third external branch link optically coupled to the third node, wherein the second external branch link includes a dispersion post-compensation means, wherein the third external branch link includes a dispersion post-compensation means, and signals transported through the second and third external branch links undergo substantially similar magnitudes and the same sign of post-compensation.

In another set of preferred embodiments disclosed herein, an optical communications system comprises: a first optical signal source capable of generating a plurality of signals at a plurality of wavelengths including a first signal; a second optical signal source capable of generating a plurality of signals at a plurality of wavelengths including a second signal; a plurality of nodes including first, second and third nodes; and a plurality of optical fiber links including interconnecting links that optically interconnect the plurality of nodes, and external branch links, each optically connected to at least one of the nodes, including a first external branch link that optically connects the first node to the first optical signal source, a second external branch link that optically connects the second node to the second optical signal source, and a third external branch link optically connected to the third node. The first signal is added at the first node, then transported to and dropped at the third node. The second signal is added at the second node, then transported to and dropped at the third node. The third external branch link includes signal dispersion post-compensation means for post-compensating the first and second signals with dispersion post-compensation of substantially similar magnitude and of the same sign.

In one preferred embodiment, the first and second signals are post-compensated to within 50 ps/nm of each other. In another preferred embodiment, the first and second signals are post-compensated to within 100 ps/nm of each other. In yet another preferred embodiment, the first and second signals are post-compensated by a magnitude of at least 50 ps/nm. In still another preferred embodiment, the first and second signals are post-compensated by a magnitude of at least 100 ps/nm. In another preferred embodiment, the first and second signals are post-compensated by a magnitude of at least 500 ps/nm. In still another preferred embodiment, the first and second signals are post-compensated by a magnitude of at least 1000 ps/nm.

In one preferred embodiment, the first and second external branch links include respective signal dispersion pre-compensation means for pre-compensating the first and second signals with a substantially similar amount of pre-compensation.

Preferably, the optical signal source comprises one or more transmitters.

Preferably, greater than 50%, more preferably greater than 80%, and even more preferably all of the dropped signals are each post-compensated by a substantially similar magnitude and with the same sign.

In still another set of preferred embodiments disclosed herein, an optical communications system comprises: at least one optical signal source capable of generating a plurality of signals at a plurality of wavelengths, including first and second signals; a plurality of nodes including first, second and third nodes; and a plurality of optical fiber links including interconnecting links, that optically interconnect the plurality of nodes, and external branch links, each optically connected to at least one of the nodes, including at least one external branch link that is optically connected to the at least one optical signal source; and at least one signal dispersion pre-compensation means optically coupled to the at least one external branch link that is optically connected to the at least one optical signal source. The first and second signals travel respective optical paths having substantially different distances. The first and second signals are pre-compensated by a substantially similar magnitude and with the same sign.

The first and second signals may be dropped at the same node, and/or the first and second signals may be added at the same node. For example, the first signal may be added at the first node, then transported to and dropped at the second node, and the second signal may also be added at the first node, then transported to and dropped at the third node.

The signal dispersion pre-compensation means preferably comprises a small number of devices through each of which multiple signals pass. More preferably, the signal dispersion pre-compensation means consists of a single device through which both the first and second signals pass.

Preferably, the first and second signals temporally overlap. Preferably, the first and second signals temporally overlap and occur in at least one common location in the network.

Preferably, the first and second signals are each pre-compensated substantially simultaneously.

The system preferably further comprises a second external branch link optically coupled to the second node, and at least one receiver may be optically coupled to the second node by the second external branch link. The system preferably further comprises a third external branch link optically coupled to the third node. The second external branch link may include a dispersion post-compensation means, wherein the third external branch link includes a dispersion post-compensation means, and signals transported through the second and third external branch links undergo substantially similar magnitudes and the same sign of post-compensation.

In yet another set of preferred embodiments disclosed herein, an optical communications system comprises: a plurality of nodes including first, second and third nodes; a plurality of optical fiber links including interconnecting links that optically interconnect the plurality of nodes, and external branch links, each external branch link optically connected to at least one of the nodes, including at least one external branch link capable of delivering a signal to a node, and at least one external branch link capable of delivering a signal from a node; and signal dispersion pre-compensation means optically coupled to the at least one external branch link capable of delivering a signal to a node. The first and second signals are capable of traveling respective optical paths of substantially different lengths before being dropped. The first and second signals are pre-compensated by a substantially similar magnitude and with the same sign. The first and second signals may be added at the same node, and/or the first and second signals may be dropped at the same node.

In still another set of preferred embodiments disclosed herein, an optical communications system comprises: a plurality of nodes including first, second and third nodes; a plurality of optical fiber links including interconnecting links that optically interconnect the plurality of nodes, and external branch links, each external branch link optically connected to at least one of the nodes, including at least one external branch link capable of delivering a signal to a node, and at least one external branch link capable of delivering a signal from a node; and signal dispersion post-compensation means optically coupled to the at least one external branch link capable of delivering a signal from a node. The first and second signals are capable of traveling respective optical paths of substantially different lengths before being dropped. The first and second signals are post-compensated by a substantially similar magnitude and with the same sign. The first and second signals may be added at the same node, and/or the first and second signals may be dropped at the same node.

Generally, the use of large dispersion pre-compensation (e.g. large negative dispersion) can result in a large dispersion induced eye-closure penalty for the transmitted signals, and consequently the signal performance will degrade. However, when the signals originate from the transmitters, optical signal-to-noise-ratio (OSNR) of the signals is very large, and acceptable signal performance can be obtained.

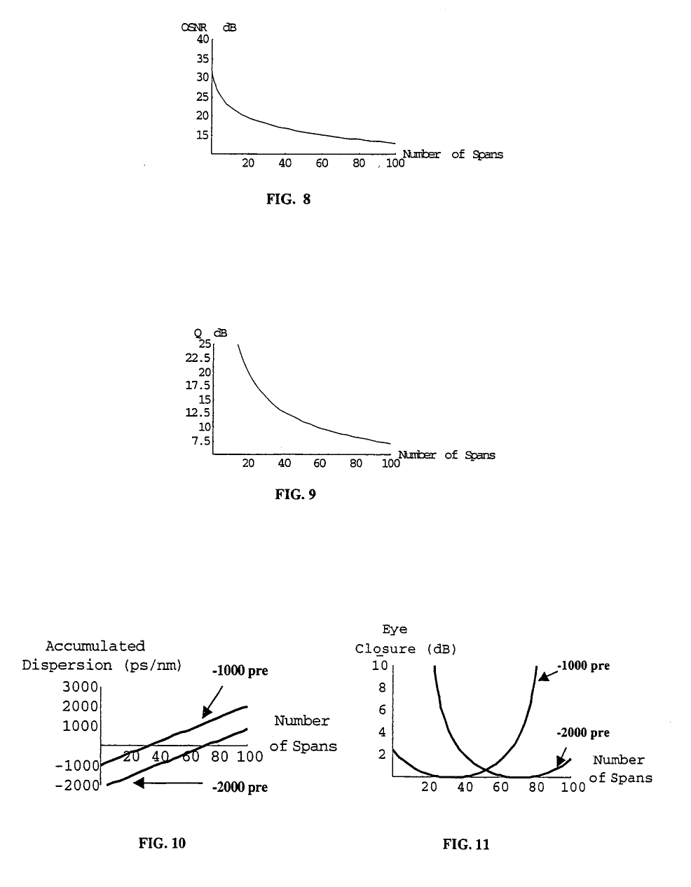

FIGS. 8 and 9 respectively show calculated values of the OSNR and the Q-factor derived only from the OSNR as 80 signals travel through Raman-amplified 80 km spans with a per-span under-compensation of 30 ps/nm. Here, only the OSNR reduction is assumed to degrade the signal performance. As the signals propagate through the network the OSNR will degrade but the absolute value of the accumulated dispersion will be reduced. Q, or Q-factor, as used herein is reported in terms of 10 log Q.

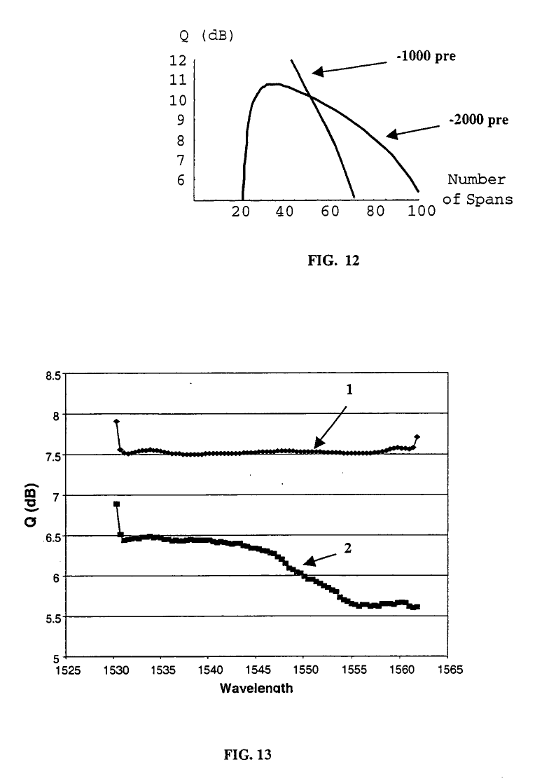

FIG. 10 shows the accumulated dispersion for a per-span under-compensation of 30 ps/nm and different amounts of pre-compensation, −1000 ps/nm and −2000 ps/nm. The calculated dispersion-induced eye-closure penalty evolution for the two cases is shown in FIG. 11. As evident from these results, the quality of the signals as they propagate along the network-path will degrade due to OSNR reduction but will improve due to smaller values of accumulated dispersion. The combined effect in the signal performance for these dispersion maps can be observed in FIG. 12. At some point along these signal-paths, the accumulated dispersion will take on positive values and its absolute value or magnitude will start to increase. For small values of the accumulated dispersion, the performance will not be significantly affected by dispersion-induced eye-closure penalty. However, eventually the magnitude of the dispersion will take on such large values that the performance will quickly drop below acceptable levels. Preferably, the Q factor is greater than about 7 dB. In this example for the case of −1000 ps/nm pre-compensation, the optical path distance at which such large values of dispersion occur is estimated to be about 5000 km. FIG. 12 shows that although a larger pre-compensation value might optimize the performance at longer reaches, acceptable performance may not be achieved at shorter reaches due to large dispersion-induced penalties.

A solution with broadband post-compensation and no pre-compensation can result in similar advantages in terms of networking applications, i.e. add/drop capability at any point across the network, monotonically decreased Q-factor as a function of distance. However, post-compensation without pre-compensation in otherwise similar networks generally would tend to limit the reach of the system by several hundred kilometers (as compared to pre-compensation only) because post-compensation will reduce the linear dispersion penalty but will not help in reducing non-linear penalties as much as the pre-compensation-only solution.

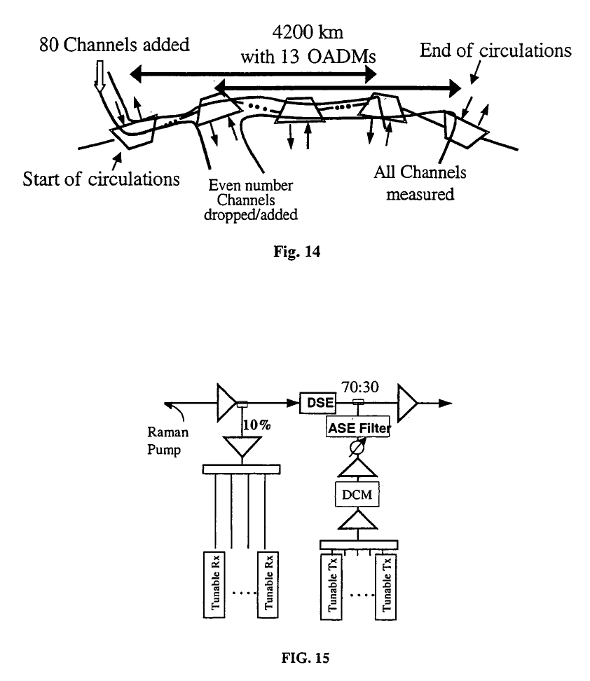

FIG. 13 presents a simulation comparison of the use of pre-compensation only with the use of post-compensation only for transmission at 10 Gb/s over LEAF® optical fiber of Corning Incorporated. The optimized post-compensation case (300 ps/nm), shown by line 2 in FIG. 13, results in about 2 dB Q-factor penalty relative to the pre-compensation case (−800 ps/nm), shown by line 1, as seen for example at 1550 nm in FIG. 13.

### EXAMPLE

In the experimental network setup schematically depicted in FIG. 14, eighty (80) channels were added at one node occupied by a broadcast-and-select optical add/drop multiplexer (B&S OADM). The 80 channels propagated over 1600 km of optical fiber (passing through 4 OADMs) and at the fifth OADM 50% of the signal traffic, i.e. an even number of channels, was dropped and 50% new traffic was added, whereafter the new set of 80 channels were circulated to the remaining spans.

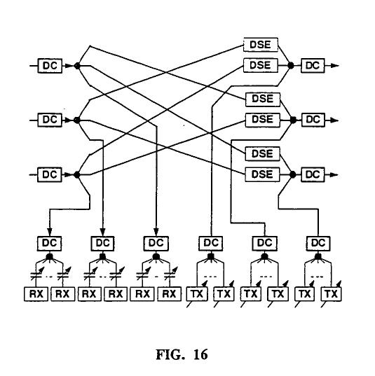

The optical add/drop multiplexers (OADMs) or optical cross-connect nodes (OXCs) utilized in the setup were based on “broadcast-and-select” architecture (B&S), enabled by a wavelength-selective switch. The B&S OADM architecture is schematically illustrated in FIG. 15 for an OADM and in FIG. 16 for an OXC. The architecture comprises a 1×1 wavelength-selective switch or blocker, such as the DSE™ wavelength-selective switch from Corning Incorporated, Corning, N.Y., in combination with 1×2 power splitters/combiners to perform traffic add/drop and proper amplification to compensate for fixed OADM losses.

Referring again to the OADM architecture of FIG. 15, all incoming traffic is split into two paths for drop and pass-through. In the drop path, the dropped traffic is selected by a combination of a power splitter (1×N, where N is the number of simultaneously accessible DWDM channels) and tunable filters. EDFAs are represented in FIG. 15 by triangle symbols. Tunable receivers (RX) are connected to a passive splitter. Tunable transmitters (Tx) are connected to a passive combiner. Circle with arrow through it is a variable optical attenuator. Passive couplers are shown on either side of the DSE in FIG. 15 by small boxes. The dropped traffic can then be delivered to one or more receivers, Rx. In the pass-through path, the dropped traffic is blocked by the DSE and the available channel slots can be filled by signals coming from the add-path. The add-path consists of N tunable transmitters and a N×1 power combiner to provide the added traffic. An EDFA is used to compensate for losses in the add-path and the WDM comb is then filtered by another DSE, where the DSE acts primarily as an ASE filter. A variable optical attenuator is shown disposed in the add-path downstream of the second EDFA. Broadband dispersion pre-compensation can be performed at the mid-stage of the EDFA at the add-path. The DSEs in this architecture can achieve blocking for some of the channels and simultaneous power leveling for the pass-through and added traffic. EDFAs are placed at the input and the output of the OADM to maintain a proper power level for the dropped and pass-through traffic. Thus, an external branch link 15 comprises, in one preferred embodiment, a drop path and an add path. In FIG. 15, the precompensator is a dispersion compensation module.

As seen in FIG. 16, a combination of DSEs, power splitters/combiners, tunable transmitters/filters and EDFAs is used in a similar way to implement a B&S 3×3 OXC. Receivers are preceded by tunable filters, and transmitters are tunable, as with the architecture of FIG. 15. With the B&S architecture, broadband dispersion pre-compensation can be achieved for all added channels. A Dispersion Compensation Module (DCM) with dispersion slope compensation capability, can be placed in the mid-stage of the EDFA used for boosting the power of the added channels to an appropriate power level before transmission in the fiber, as seen FIG. 16. Thus, broadband multichannel pre-compensation by a single DCM can be obtained. If connection specific dispersion tuning is required in an optical network, then per-channel settable (or even tunable) dispersion compensators would be needed, although such a solution might be cost-prohibitive.

The experimental network setup included 4200 km of dispersion managed fiber (52×80 km spans) and 13 concatenated B&S OADMs spaced at 320 km. The dispersion map comprised fixed broadband pre-compensation at the transmitters, per span under-compensation, and no post-compensation at the receiver. Performance of DWDM C-band transmission at 10.7 Gb/s with 50 GHz channels spacing and 0.2 spectral efficiency was achieved on an NRZ format with less than 10-15 Bit-Error-Rate (BER) operation. Traffic add/drop was possible at any point across the network with performance above acceptable levels. Various dispersion maps for enabling ULH transmission with the capability of traffic add/drop at any point in the network link were evaluated.

The performance of the pass-through channels (bypassing the fifth OADM) was measured after 4200 km and 13 concatenated OADMs. The performance for the newly added traffic at the fifth OADM (after 1600 km) was also measured after 4200 km transmission and 13 concatenated OADMs. The average Q-factor was 7.24 dB for the 40 pass-through channels and 7.13 dB for the added channels (10.7 Gb/s bit-rate per channel). No significant performance difference between the two groups of channels was observed.

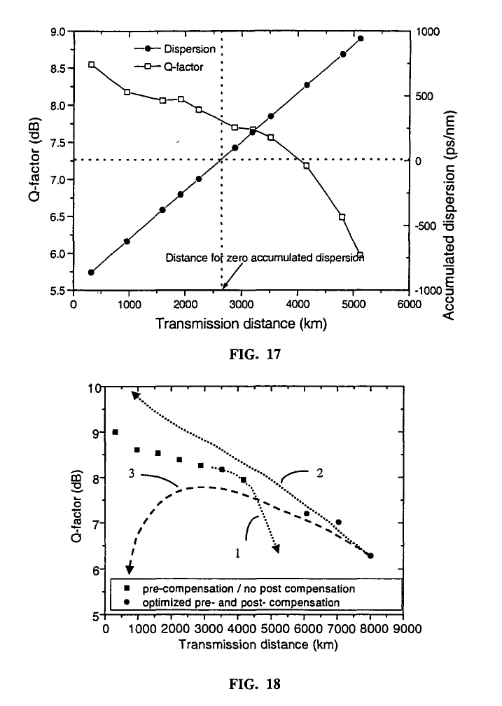

FIG. 17 graphically illustrates the Q-factor performance and accumulated dispersion for channel 25 as a function of transmission distance through the network. As seen in FIG. 17, for the particular dispersion map used (fixed broadband pre-compensation at the transmitters, per span under-compensation and no post-compensation at the receiver), the Q-factor performance degraded monotonically as a function of distance, thereby allowing the capability for traffic add-drop at any point in the network.

As seen in FIG. 17, the particular dispersion map utilized enables transparent un-regenerated reach in an ULH network of up to 5000 km. Other dispersion schemes could be developed for networks having greater transparent reaches. For example, optimum pre- and post-compensations were selected for achieving 6080 km, 7040 km, and 8000 km transparent reach. A transparent reach of 6080 km was achieved using the above experimental setup with optimum values of −986 ps/nm pre-compensation and −493 ps/nm post-compensation. As another example, a transparent reach of 7040 km was achieved using the above experimental setup with optimum values of 1315 ps/nm pre-compensation and −657 ps/nm post-compensation. By way of another example, a transparent reach of 8000 km was achieved using the above experimental setup with optimum values of 1315 ps/nm pre-compensation and −821 ps/nm post-compensation.

FIG. 18 graphically illustrates the Q-factor performance results for 10 Gb/s signals, showing the trend for the Q-factor performance vs. distance. Line 1 and the square data points correspond to pre-compensation only (no post-compensation), with per-span dispersion under-compensation. Line 2 and the circle data points represent the trend for optimized pre- and post-compensation for every distance. Dashed line 3 represents the case of using a fixed pre- and post-compensation to optimize the performance for the maximum reach.

The results shown in FIG. 18 suggest that, for extended reach, a solution utilizing fixed pre- and post-compensation optimized for the maximum reach will require in this case tunable per channel post-compensation or even tunable pre-compensation in order to get satisfactory performance for shorter paths in the network. This may prove to be too costly to implement. Alternatively, further reduction of the residual dispersion per span may enable satisfactory performance over a wider range of connection distances without resorting to the use of tunable per-channel dispersion compensation.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description, serve to explain the principals and operation of the invention. It will become apparent to those skilled in the art that various modifications to the preferred embodiment of the invention as described herein can be made without departing from the spirit or scope of the invention as defined by the appended claims.

What is claimed is:

1. A method of communicating over an optical network having a plurality of add/drop nodes interconnected by optical fiber, the method comprising:
producing a plurality of optical signals, including first and second optical signals;
pre-compensating the dispersion of the first and second signals by a similar magnitude and with the same sign;
transporting the first signal to a first drop location; and
transporting the second signal to a second drop location.

2. The method of claim 1 wherein the first and second optical signals are produced at a common source location.

3. The method of claim 1 wherein the first and second optical signals are produced at different source locations.

4. The method of claim 1 further comprising, after carrying the first and second signals to the respective first and second drop locations, post-compensating the first and second signals by a similar magnitude and with the same sign.

5. The method of claim 1 wherein the plurality of optical signals are produced at a plurality of source locations.

6. The method of claim 5 wherein greater than 25% of all of the optical signals produced are dispersion pre-compensated by a similar magnitude and with the same sign.

7. The method of claim 5 wherein greater than 50% of all of the optical signals produced are dispersion pre-compensated by a similar magnitude and with the same sign.

8. The method of claim 1 wherein the plurality of optical signals are produced at a common source location

9. The method of claim 8 wherein greater than 50% of the optical signals produced at the common source location are dispersion pre-compensated by a similar magnitude and with the same sign.

10. The method of claim 1 wherein the first and second signals temporally overlap.

11. A method of communicating over an optical network having a plurality of add/drop nodes interconnected by optical fiber, the method comprising:
producing a first second optical signal at a first source location;
producing a second optical signal at a second source location;
carrying the first and second signals to a common drop location; and
post-compensating the first and second signals by a similar magnitude and with the same sign.

12. The method of claim 11 further comprising, before carrying the first and second signals to a common drop location, pre-compensating the dispersion of the first and second signals by a similar magnitude and with the same sign.

13. The method of claim 11 wherein greater than 50% of all of the optical signals dropped are dispersion post-compensated by a similar magnitude and with the same sign.

14. The method of claim 11 wherein substantially all of the optical signals dropped are dispersion post-compensated by a similar magnitude and with the same sign.

15. The method of claim 11 wherein greater than 25% of the optical signals produced at the common source location are dispersion post-compensated by a similar magnitude and with the same sign.

16. The method of claim 11 wherein greater than 50% of the optical signals produced at the common source location are dispersion post-compensated by a similar magnitude and with the same sign.

17. An optical communications system comprising:
an optical signal source capable of generating a plurality of signals at a plurality of wavelengths, including first and second signals;
a plurality of nodes including first, second and third nodes;
a plurality of optical fiber links including:
interconnecting links that optically interconnect the plurality of nodes; and
external branch links, each external branch linkoptically connected to at least one of the nodes, including a first external branch link that optically connects the first node to the optical signal source; and
a signal dispersion pre-compensation means optically coupled to the first external branch link;
wherein the first and second signals are pre-compensated by a substantially similar magnitude and with the same sign prior to entering the first node;
wherein the first signal is added at the first node, then transported to and dropped at the second node; and
wherein the second signal is added at the first node, then transported to and dropped at the third node.

18. The method of claim 17 wherein the optical fiber span comprises at least one optical fiber section having a positive dispersion at a wavelength and at least one optical fiber section having a positive dispersion at the wavelength.

19. The method of claim 18 wherein the optical fiber span comprises optically coupled first, second and third optical fiber sections, the first optical fiber section having a dispersion of negative or positive sign at a wavelength, the second optical fiber section having a dispersion of opposite sign at the wavelength, and the third optical fiber section having a dispersion of like sign at the wavelength.

20. The method of claim 18 wherein the magnitude of the per span residual dispersion is greater than about 10 ps/nm.

21. The method of claim 18 wherein the magnitude of the per span residual dispersion is less than about 10 ps/nm.

22. The method of claim 17 wherein the first and second signals are pre-compensated to within 50 ps/nm of each other.

23. The method of claim 17 wherein at least one signal enters a first node, transits through a second node, and is dropped at a third node.

24. The method of claim 17 wherein greater than 50% of the signals generated by the optical signal source are each compensated with compensation having substantially similar magnitude and the same sign prior to entry into the first node.

25. The method of claim 17 further comprising at least one other external branch link optically coupled to one of nodes, wherein the first and second signals are post-compensated, with substantially magnitude and with the same sign, within the at least one other external branch links.

26. An optical communications system comprising:
a first optical signal source capable of generating a plurality of signals at a plurality of wavelengths including a first signal;
a second optical signal source capable of generating a plurality of signals at a plurality of wavelengths including a second signal;
a plurality of nodes including first, second and third nodes; and
a plurality of optical fiber links including:
interconnecting links that optically interconnect the plurality of nodes; and
external branch links, each external branch link optically connected to at least one of the nodes, including:
a first external branch link that optically connects the first node to the first optical signal source;
a second external branch link that optically connects the second node to the second optical signal source; and
a third external branch link optically connected to the third node;
wherein the first signal is added at the first node, then transported to and dropped at the third node;
wherein the second signal is added at the second node, then transported to and dropped at the third node; and
wherein the third external branch link includes signal dispersion post-compensation means for post-compensating the first and second signals with dispersion post-compensation of substantially similar magnitude and of the same sign.

27. The method of claim 26 wherein greater than 50% of the dropped signals are each post-compensated by a substantially similar magnitude and with the same sign.
